(19) United States
(12) Patent Application Publication
(10) Pub. No.: US 2026/0127726 A1
(43) Pub. Date: May 7, 2026

(54) Machine Learning Model Based Triggering Mechanism for Image Enhancement

(71) Applicant: Google LLC, Mountain View, CA (US)

(72) Inventors: Hossein Talebi, San Jose, CA (US); Sungjoon Choi, Los Altos, CA (US); Peyman Milanfar, Menlo Park, CA (US); Mauricio Delbracio, Sunnyvale, CA (US)

(21) Appl. No.: 19/117,905

(22) PCT Filed: Oct. 4, 2023
(86) PCT No.: PCT/US2023/034434

§ 371 Date: Apr. 2, 2025

Related U.S. Application Data
(60) Provisional application No. 63/378,386, filed on Oct. 5, 2022.

(51) Int. Cl. G06T 7/00; G06T 5/60; G06T 5/70; G06T 5/73

(52) U.S. Cl. CPC G06T 7/0002; G06T 5/60; G06T 5/70; G06T 5/73; G06T 2207/20081; G06T 2207/20084; G06T 2207/30168

(57) ABSTRACT

A method includes determining a respective delta quality score associated with each of a plurality of images by predicting, by an image enhancement model, an enhanced image corresponding to a given image, determining a first quality score associated with the given image and a second quality score associated with the enhanced image. The delta quality score is based on a difference of the first and second quality scores. The method includes generating a training dataset comprising the plurality of images associated with respective delta quality scores. The method includes training, based on the generated training dataset, a quality assessment model to predict a quality-improvability score associated with an input image. The quality-improvability score is indicative of a potential to increase a perceptual quality of the input image based on removal of one or more image degradation factors. The method includes outputting, by the computing device, the trained quality assessment model.

### CROSS-REFERENCE TO RELATED APPLICATIONS/INCORPORATION BY REFERENCE

This application claims priority to U.S. Provisional Patent Application No. 63/378,386, filed on Oct. 5, 2022, which is hereby incorporated by reference in its entirety.

### BACKGROUND

Many modern computing devices, including mobile phones, personal computers, and tablets, include image capture devices, such as still and/or video cameras. The image capture devices can capture images, such as images that include people, animals, landscapes, and/or objects. Some image capture devices and/or computing devices can correct or otherwise modify captured images. For example, some image capture devices can provide “red-eye” correction that removes artifacts such as red-appearing eyes of people and animals that may be present in images captured using bright lights, such as flash lighting. After a captured image has been corrected, the corrected image can be saved, displayed, transmitted, printed to paper, and/or otherwise utilized.

### SUMMARY

Removing blur, noise and compression artifacts from images are longstanding problems in computational photography. Image degradations can come from several sources. When the photographer or the autofocus system incorrectly sets the focus (out-of-focus), or when the relative motion between the camera and the scene is faster than the shutter speed (motion blur). Additionally, even in ideal acquisition conditions, there can be an intrinsic camera blur due to sensor resolution, light diffraction, lens aberrations, and anti-aliasing filters. Similarly, image noise is intrinsic to the capture of a discrete number of photons (shot-noise), and the analog-to-digital conversion and processing (read out noise). In general, images are compressed, such as by using JPEG compression, before storage or transmission. The image compression can also degrade the image quality.

Powered by a system of machine-learned components, an image capture device may be configured to generate a trigger based on a determination that an image should be enhanced. The trigger may alert users, and users may be provided with recommendations to remove blur, noise, compression artifacts, and so forth, to create sharp images. In some aspects, mobile devices may be configured with these features so that an image can be enhanced in real-time. In some instances, an image may be automatically enhanced by the mobile device. In other aspects, mobile phone users can non-destructively enhance an image to match their preference. Also, for example, pre-existing images in a user's image library can be enhanced based on techniques described herein.

In one aspect, a computer-implemented method is provided. The method includes determining a respective delta quality score associated with each of a plurality of images, wherein the determining of the delta quality score comprises: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image. The method includes generating, by a computing device, a training dataset comprising the plurality of images associated with respective delta quality scores. The method includes training, based on the generated training dataset, a quality assessment model to predict a quality-improvability score associated with an input image, wherein the quality-improvability score is indicative of a potential to increase a perceptual quality of the input image based on removal of one or more image degradation factors. The method includes outputting, by the computing device, the trained quality assessment model.

In another aspect, a computing device is provided. The computing device includes one or more processors and data storage. The data storage has stored thereon computer-executable instructions that, when executed by one or more processors, cause the computing device to carry out functions. The functions include: determining a respective delta quality score associated with each of a plurality of images, wherein the determining of the delta quality score comprises: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image: generating, by the computing device, a training dataset comprising the plurality of images associated with respective delta quality scores: training, based on the generated training dataset, a quality assessment model to predict a quality-improvability score associated with an input image, wherein the quality-improvability score is indicative of a potential to increase a perceptual quality of the input image based on removal of one or more image degradation factors; and outputting, by the computing device, the trained quality assessment model.

In another aspect, a computer program is provided. The computer program includes instructions that, when executed by a computing device, cause the computing device to carry out functions. The functions include: determining a respective delta quality score associated with each of a plurality of images, wherein the determining of the delta quality score comprises: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image: generating, by the computing device, a training dataset comprising the plurality of images associated with respective delta quality scores: training, based on the generated training dataset, a quality assessment model to predict a quality-improvability score associated with an input image, wherein the quality-improvability score is indicative of a potential to increase a perceptual quality of the input image based on removal of one or more image degradation factors; and outputting, by the computing device, the trained quality assessment model.

In another aspect, an article of manufacture is provided. The article of manufacture includes one or more computer readable media having computer-readable instructions stored thereon that, when executed by one or more processors of a computing device, cause the computing device to carry out functions. The functions include: determining a respective delta quality score associated with each of a plurality of images, wherein the determining of the delta quality score comprises: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image: generating, by the computing device, a training dataset comprising the plurality of images associated with respective delta quality scores: training, based on the generated training dataset, a quality assessment model to predict a quality-improvability score associated with an input image, wherein the quality-improvability score is indicative of a potential to increase a perceptual quality of the input image based on removal of one or more image degradation factors; and outputting, by the computing device, the trained quality assessment model.

In another aspect, a system is provided. The system includes means for determining a respective delta quality score associated with each of a plurality of images, wherein the determining of the delta quality score comprises: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image: means for generating, by a computing device, a training dataset comprising the plurality of images associated with respective delta quality scores: means for training, based on the generated training dataset, a quality assessment model to predict a quality-improvability score associated with an input image, wherein the quality-improvability score is indicative of a potential to increase a perceptual quality of the input image based on removal of one or more image degradation factors; and means for outputting, by the computing device, the trained quality assessment model.

In another aspect, a computer-implemented method is provided. The method includes receiving, by a computing device, an input image. The method also includes predicting, by a quality assessment model, a quality-improvability score associated with the input image, wherein the quality-improvability score is indicative of a potential to increase a perceptual quality of the input image based on removal of one or more image degradation factors, the quality assessment model having been trained on a training dataset comprising a plurality of images associated with respective delta quality scores, the delta quality scores having been determined by: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image. The method additionally includes providing, by the computing device, an alert notification based on the predicted quality-improvability score.

In another aspect, a computing device is provided. The computing device includes one or more processors and data storage. The data storage has stored thereon computer-executable instructions that, when executed by one or more processors, cause the computing device to carry out functions. The functions include: receiving, by the computing device, an input image; predicting, by a quality assessment model, a quality-improvability score associated with the input image, wherein the quality-improvability score is indicative of a potential to increase a perceptual quality of the input image based on removal of one or more image degradation factors, the quality assessment model having been trained on a training dataset comprising a plurality of images associated with respective delta quality scores, the delta quality scores having been determined by: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image; and providing, by the computing device, an alert notification based on the predicted quality-improvability score.

In another aspect, a computer program is provided. The computer program includes instructions that, when executed by a computing device, cause the computing device to carry out functions. The functions include: receiving, by the computing device, an input image; predicting, by a quality assessment model, a quality-improvability score associated with the input image, wherein the quality-improvability score is indicative of a potential to increase a perceptual quality of the input image based on removal of one or more image degradation factors, the quality assessment model having been trained on a training dataset comprising a plurality of images associated with respective delta quality scores, the delta quality scores having been determined by: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image; and providing, by the computing device, an alert notification based on the predicted quality-improvability score.

In another aspect, an article of manufacture is provided. The article of manufacture includes one or more computer readable media having computer-readable instructions stored thereon that, when executed by one or more processors of a computing device, cause the computing device to carry out functions. The functions include: receiving, by the computing device, an input image: predicting, by a quality assessment model, a quality-improvability score associated with the input image, wherein the quality-improvability score is indicative of a potential to increase a perceptual quality of the input image based on removal of one or more image degradation factors, the quality assessment model having been trained on a training dataset comprising a plurality of images associated with respective delta quality scores, the delta quality scores having been determined by: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image; and providing, by the computing device, an alert notification based on the predicted quality-improvability score.

In another aspect, a system is provided. The system includes means for receiving, by a computing device, an input image: means for predicting, by a quality assessment model, a quality-improvability score associated with the input image, wherein the quality-improvability score is indicative of a potential to increase a perceptual quality of the input image based on removal of one or more image degradation factors, the quality assessment model having been trained on a training dataset comprising a plurality of images associated with respective delta quality scores, the delta quality scores having been determined by: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image; and means for providing, by the computing device, an alert notification based on the predicted quality-improvability score.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates an example framework for generating delta quality scores, in accordance with example embodiments.

FIG. 2 illustrates an example framework for training a baseline quality assessment model, in accordance with example embodiments.

FIG. 3 illustrates an example framework for fine-tuning a baseline quality assessment model, in accordance with example embodiments.

FIG. 4 illustrates an example inference by a quality assessment model, in accordance with example embodiments.

FIG. 5 is a table illustrating correlation values obtained from a baseline quality assessment model during training and testing, in accordance with example embodiments.

FIG. 6 illustrates an example comparison of a baseline quality assessment model and a fine-tuned quality assessment model, in accordance with example embodiments.

FIG. 7 illustrates example applications of a quality assessment model, in accordance with example embodiments.

FIG. 8 is a diagram illustrating training and inference phases of a machine learning model, in accordance with example embodiments.

FIG. 9 depicts a distributed computing architecture, in accordance with example embodiments.

FIG. 10 is a block diagram of a computing device, in accordance with example embodiments.

FIG. 11 depicts a network of computing clusters arranged as a cloud-based server system, in accordance with example embodiments.

FIG. 12 is a flowchart of a method, in accordance with example embodiments.

FIG. 13 is a flowchart of another method, in accordance with example embodiments.

### DETAILED DESCRIPTION

An approach for developing a quality assessment model is described, to predict a quality-improvability score for an input image. The quality-improvability score indicates whether an image can benefit from image enhancement techniques. In some embodiments, a trigger model can be trained based on the quality-improvability score, where the trigger model can be used in tandem with image enhancement algorithms. Also, for example, an image ranking model can be trained based on the quality-improvability score to rank images that can benefit most from image enhancement.

Photo restoration operations such as denoising and deblurring improve the visual quality of distorted images. However, identifying such images may not be a straightforward task. Given an input image, a reliable trigger model should predict a degree of visual improvement from applying a specific restoration and/or enhancement algorithm. Moreover, typically due to the computational overhead, it may not be practical to run an enhancement model and use its output to make the triggering decision. Also, for example, it is desirable to know a degree to which an image may be enhanced, prior to applying an image enhancement model. This may be to avoid possibly degrading image quality, saving computational resources by not applying image enhancement when the degree of possible enhancement is minimal, and/or to perceptibly increase image quality. As described herein, a framework to develop a lightweight trigger model is described which can be reliably used for surfacing images that benefit the most from enhancement algorithms such as but not limited to, motion deblurring, denoising, and compression artifact removal.

In one example, (a copy of) the trained quality assessment model can reside on a mobile computing device. The mobile computing device can include a camera that can capture an input image. A trained quality assessment model (e.g., residing on the mobile computing device) may predict an image quality-improvability score for the input image, and a user of the mobile computing device can be provided with a recommendation that the input image should be sharpened. The user can then choose to enhance the image, and the input image may be provided to a trained image enhancement model (e.g., residing on the mobile computing device, or at a remote server) for image enhancement. In response, the trained image enhancement model can generate a predicted output image that is a sharper version of the input image, and subsequently output the output image (e.g., provide the output image for display by the mobile computing device). In other examples, the trained quality assessment model is not resident on the mobile computing device: rather, the mobile computing device provides the input image to a remotely-located trained quality assessment model (e.g., via the Internet or another data network). The remotely-located trained quality assessment model can process the input image and provide an output quality-improvability score to the mobile computing device. In other examples, non-mobile computing devices can also use the trained quality assessment model to predict quality-improvability scores, including for images that are not captured by a camera of the computing device.

In some examples, the trained quality assessment model can work in conjunction with other neural networks (or other software) and/or be trained to recognize whether an input image has image degradations. Then, upon a determination that an input image has image degradations, the herein-described trained quality assessment model could provide the input image to a trained image enhancement model, thereby removing the image degradations in the input image.

As such, the herein-described techniques can improve images by removing image degradations (e.g., automatically, or in response to a user-indication), thereby enhancing their actual and/or perceived quality. Enhancing the actual and/or perceived quality of images, including portraits of people, can provide emotional benefits to those who believe their pictures look better. These techniques are flexible, and so can apply to images of human faces and other objects, scenes, and so forth.

### Overview

Typically for triggering purposes, image enhancement algorithms either rely on hand-crafted features or deep machine learning (ML) models. Obtaining reliable hand-crafted features such as noise or blur estimation may be challenging, especially when the camera pipeline is unknown. On the other hand, training a deep ML trigger model requires curating large-scale labeled data.

The approach described herein overcomes such challenges by relying on existing perceptual quality assessment models, and requires a few hundred labeled examples (as opposed to a large number of labeled examples required by existing assessment models). The proposed approach can be a two-step semi-supervised approach in which the deep trigger model is first trained with image quality scores (e.g., neural image assessment (NIMA) scores), and then the trigger model can be fine-tuned with a small number of labeled data. This enables knowledge transfer from NIMA (which is sensitive to blur, noise, and other degradations) to the underlying trigger task without the necessity of curating thousands of ratings from human subjects. Note that NIMA may be generalized to real image degradations, however, any robust image quality assessment model can be used as part of the framework described herein.

### Training an Example Baseline Model

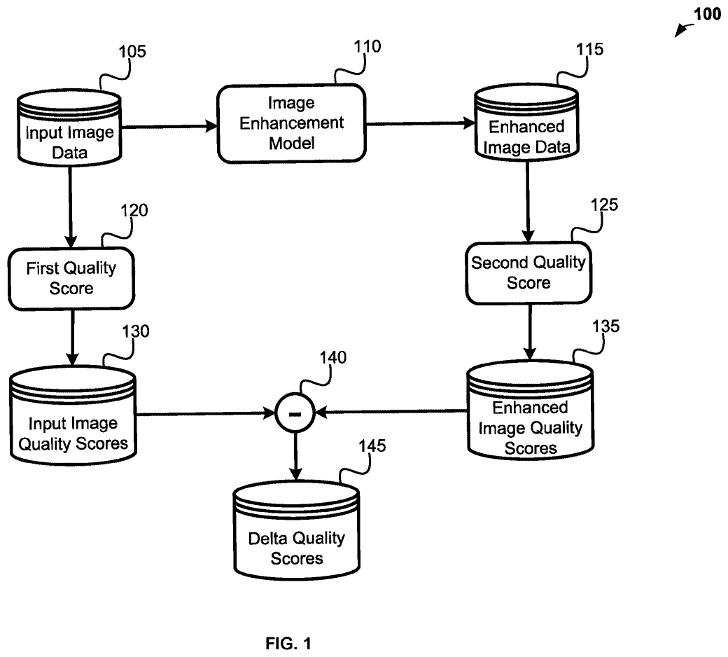

FIG. 1 illustrates an example framework 100 for generating delta quality scores, in accordance with example embodiments. The process of training the baseline trigger model is shown in FIG. 1. As illustrated, an image enhancement model 110 (e.g., a DeepMode model) can be run on a plurality of images, such as a dataset of unlabeled data, input image data 105. In some embodiments, approximately 500,000 images may be used. Image enhancement model 110 predicts their respective enhanced counterparts, such as enhanced images corresponding to a given image of the plurality of images, and collected as enhanced image data 115. The image enhancement model 110 may be trained to remove one or more image degradations associated with the given image.

In some embodiments, the image enhancement model can be, a deblurring model, a colorization model, an image artifact removal model, or a denoising model, among others. An image enhancement model, such as a convolutional neural network (different from the CNN described earlier with reference to a quality assessment model), can be trained using a training data set of images to perform one or more aspects as described herein. In some examples, the neural network can be arranged as an encoder/decoder neural network.

In some embodiments, a Deep Motion, Out-of-focus, and Degradation Enhancement (DeepMode) model may be applied to challenging cases, where an amount of blur is moderate or large and where the image presents other degradations, such as noise or JPEG compression artifacts. DeepMode may be configured to be a supervised deep-learning end-to-end solution to eliminate blur, noise, compression artifacts, and so forth, on images.

In some embodiments, a first quality score 120 associated with the given image of the plurality of images may be determined, and a second quality score 125 associated with the predicted enhanced image may be determined. In some embodiments, the first quality score 120 and the second quality score 125 may be neural image assessment (NIMA) scores. For example, NIMA scores ranging from 1 to 10, with 10 indicating images of the highest quality, may be used. In some embodiments, a NIMA model may be trained on approximately 250,000 images rated by human subjects that evaluate images for various image degradation factors such as blur, exposure, noise, and/or compression artifacts.

In some embodiments, delta quality scores may be determined based on a difference 140 of the respective second quality score (e.g., stored in enhanced image quality scores database 135) and the corresponding first quality score (e.g., stored in input image quality scores database 130), and the delta quality scores may be stored in a database of delta quality scores 145. The delta quality score is indicative of a degree of image enhancement in the predicted enhanced image. In some embodiments, the delta quality score can also indicate a degree of regression, for instance when an attempt to denoise an image that is not noisy may result in over-smoothing it. For example, the delta quality score may be determined as:

$$Delta Quality Score = Enhanced image quality score - Input image quality scores \qquad ( Eqn . 1 )$$

In particular, when applied to NIMA scores, the delta NIMA score, denoted as Δ-NIMA, may be determined as:

$$Δ - NIMA = NIMA ( Enhanced ) - NIMA ( Input ) \qquad ( Eqn . 2 )$$

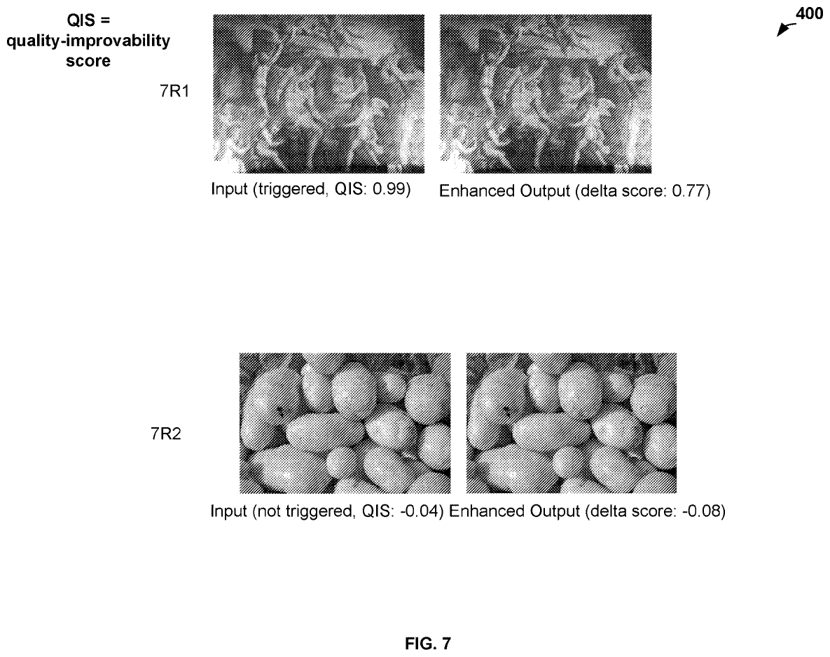

In some embodiments, the Δ-NIMA scores may range from −9 to 9. The larger the Δ-NIMA, the higher the visual quality of the enhanced image. Some examples with different Δ-NIMA scores are shown in FIG. 7.

Once the delta quality scores (e.g., Δ-NIMA scores) are computed, these may be used to train a baseline quality assessment model (e.g., a deep neural network, such as a MobileNet-V2 model).

In some embodiments, a trigger model may be trained based on the quality assessment model. For example, the trigger model may be a binary classifier that is trained to determine whether an image is to be enhanced or not. In some embodiments, the quality assessment model can be used to train an image ranking model that ranks a plurality of images based on image quality.

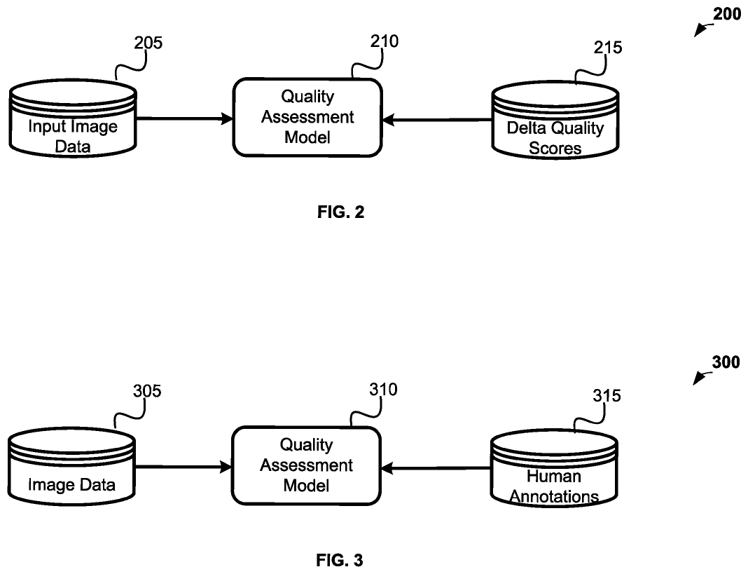

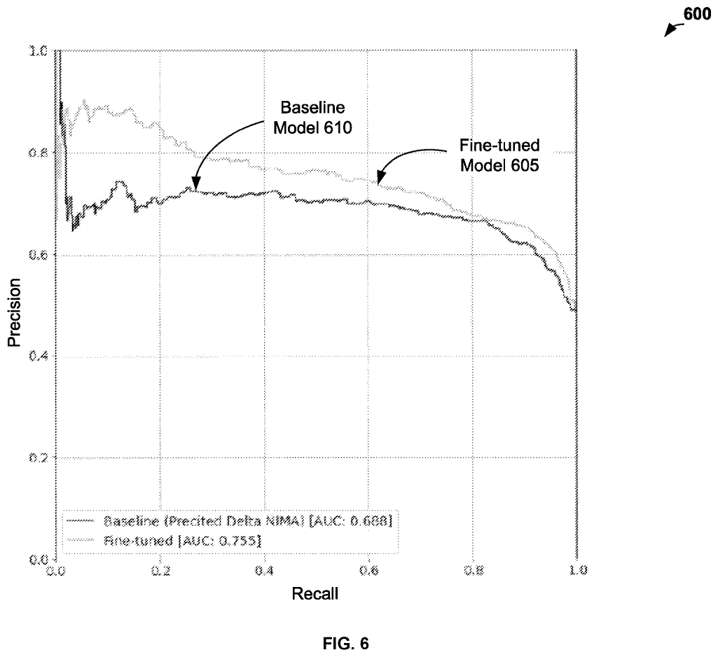

FIG. 2 illustrates an example framework 200 for training a baseline quality assessment model, in accordance with example embodiments. In some embodiments, the quality assessment model may be a convolutional neural network (CNN). In some embodiments, the CNN may comprise a MobileNet architecture. In some embodiments, image data may be of size 224×224, and input image data 205 to the quality assessment model 210 may be resized to 448×448. This can help with lowering an impact of resizing on the input degradations. Delta quality scores 215 may be provided to quality assessment model 210. In some embodiments, where quality assessment model 210 is a MobileNet model, at layer 16 of the MobileNet model, a fully connected layer may be introduced to predict the delta quality scores (e.g., Δ-NIMA scores). Also, the MobileNet model may be warm-started with weights from JFT trained checkpoints. For example, a JFT-300M dataset may be used for training image classification models. Images are labeled using an algorithm that uses a combination of web signals, connections between web-pages and user feedback. Labels in excess of one billion may be generated for the 300 million images, where a single image may be associated with multiple labels). Example correlation values obtained from a baseline quality assessment model during training and testing are illustrated in FIG. 6.

Fine-Tuning with Labels

Once the baseline quality assessment model is trained, to further improve the trigger model, a fine-tuning of the baseline quality assessment model may be performed on data rated by human annotators. The baseline model is a good approximation to a desired quality assessment model, as it captures the impact of the image enhancement.

FIG. 3 illustrates an example framework 300 for fine-tuning a baseline quality assessment model, in accordance with example embodiments. For example, approximately 1000 images processed by an image enhancement algorithm (e.g., DeepMode) may be curated, and human subjects may be asked to compare the enhanced images with input images prior to enhancement. Each pair of image data 305 and the corresponding enhanced image may be rated to provide a label, to generate human annotations 315. For example, human annotators may be photographers or other professionals experienced in discerning a perceptive quality of images. In some embodiments, the label may be “significant improvement” corresponding to a score of 2. “moderate improvement” corresponding to a score of 1, “neutral” corresponding to a score of 0, or “regressed” corresponding to a score of −1. Image data 305 and human annotations 315 may be provided to the baseline quality assessment model 310, may be used to fine-tune the baseline quality assessment model 310. In some embodiments, the data may be split into training data and test data (e.g., an 80%-20% split). In some embodiments, the fine-tuning may involve fine-tuning the last layer (e.g., layer has less than 120 trainable parameters) of a MobileNet-V2 model trained on the Δ-NIMA data. Accordingly, instead of training hundreds of thousands of parameters, only a few parameters are trained for the fine-tuning, and therefore requiring a relatively minimal number of training data. In some embodiments, the remaining weights may be loaded from the baseline quality assessment model 310 (e.g., Δ-NIMA predictor) and kept frozen during training. Once the quality assessment model is fine-tuned, it can be used to evaluate its performance on the human rated data.

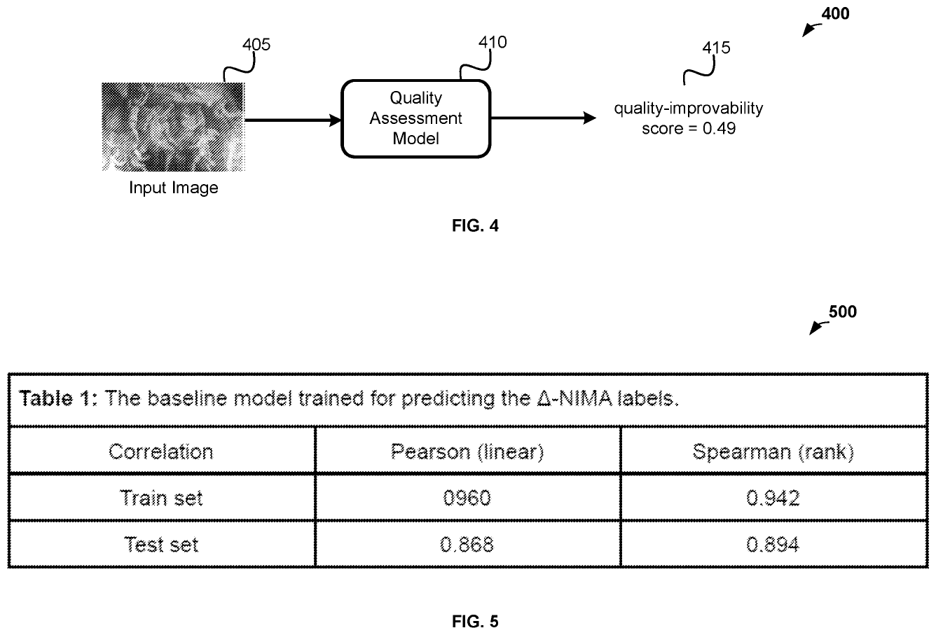

FIG. 4 illustrates an example inference 400 by a quality assessment model, in accordance with example embodiments. As illustrated, input image 405 can be provided to the quality assessment model 410, and a quality-improvability score 415 may be predicted. For example, quality assessment model 410 predicts a quality-improvability score 415 with a value 0.49 for input image 405. The output quality-improvability score 415 can be used to identify moderately and/or significantly improved images in the test set.

FIG. 5 is a table 500 illustrating correlation values obtained from a baseline quality assessment model during training and testing, in accordance with example embodiments. These values show that the baseline MobileNet is effective for predicting quality-improvability (e.g., Δ-NIMA) scores. The correlation results in table 500 validate that the quality assessment model (e.g., Δ-NIMA predictor) works as intended. The fine-tuning step occurs after the quality assessment model is trained.

The two trained models, the baseline quality assessment model, and the fine-tuned quality assessment model may be compared.

FIG. 6 illustrates an example comparison graph 600 of a baseline quality assessment model and a fine-tuned quality assessment model, in accordance with example embodiments. Graph 600 displays values for precision (along the vertical axis) against values for recall (along the horizontal axis). The precision-recall analysis of the baseline and fine-tuned trigger models are illustrated. The ground truth data is rated by human subjects. As expected, the fine-tuned model 605 performs better than the baseline model 610. The fine-tuned model 605 shows an AUC-PR of 0.755. However, the baseline model 610 also shows a solid AUC-PR of 0.688.

FIG. 7 illustrates example applications of a quality assessment model, in accordance with example embodiments. There are visual examples shown in FIG. 7 where a blurry or noisy image (e.g., in row 7R1) shows a higher quality-improvability score compared to the sharp, in-focus image at the bottom (e.g., in row 7R2). The score threshold for triggering the enhancement model is illustrated as 0.4. Accordingly, an alert notification may be triggered for the input image in row 7R1 (with a quality-improvability scores (QIS) of 0.99 which exceeds the threshold score of 0.4), whereas an alert notification may not be triggered for the input image in row 7R2 (with a quality-improvability score of −0.04, which does not exceed the threshold score of 0.4).

Some examples with different Δ-NIMA scores are also shown in FIG. 7. For example, row 7R1 illustrates an enhanced output image with a delta score of 0.77, whereas row 7R2 illustrates another enhanced output image with a delta score of −0.8. These outputs are consistent with the quality-improvability scores. For example, the image in row 7R1 has a quality-improvability score of 0.99 indicating a significant potential improvement under image enhancement, and the corresponding enhanced output image has a delta score of 0.77, indicating a significant improvement after image enhancement is performed. Similarly, the image in row 7R3 has a quality-improvability score of −0.04 indicating a low potential improvement under image enhancement (as the image is already of high quality), and the corresponding enhanced output image has a delta score of −0.08, indicating no improvement after image enhancement is performed.

### Example Image Degradations

Image blur can be generally modeled as a linear operator acting on a sharp latent image. For a shift-invariant linear operator, the blurring operation may amount to a convolution with a blur kernel. In practice, a common assumption is that captured images include additive noise and compression in addition to blurring. According, the following relation may apply:

$$v = C ( S ( u * k ) + n ) , \qquad ( Eqn . 3 )$$

where v is the captured image, u is the underlying sharp image, k is the unknown blur kernel, * is a convolution operation, n is additive noise, S models the sensor non-linear response (e.g., saturation), and C represents image compression. Some existing techniques perform image deblurring by viewing the problem as a “blind” deconvolution process. For example, in the first step, a blur kernel may be estimated. This may be achieved by assuming a sharp image model, for example, by using a variational framework, while in a second independent step a “non-blind” deconvolution algorithm may be applied. However, image noise and artifacts resulting from compression may negatively impact both steps. Even in the case where the blur kernel may be determined, “non-blind” deconvolution may be an ill-posed problem, and the presence of noise, compression, and so forth, may lead to artifacts. A significant drawback of model-based deblurring is that the degradation model generally has to have a high degree of accuracy. This may pose significant challenges in practice, due to several unknown, or partially known image transformations (e.g., unknown blur, unknown camera image signal processor (ISP), post-processing, compression, and so forth).

To remove the one or more image degradations, the herein-described techniques may apply an image enhancement model (e.g., based on a convolutional neural network) to predict a sharp image. Although a particular image enhancement model is described for illustrative purposes, the quality assessment model described with reference to FIGS. 1-7 can be implemented in tandem with any image enhancement model.

The term “degradation factor” as used herein, generally refers to any factor that affects a sharpness of an image, such as, for example, a clarity of the image with respect to quantitative image quality parameters such as contrast, focus, and so forth. In some embodiments, the one or more degradation factors may include one or more of a motion blur, a lens blur, an image noise, an image compression artifact, or an artifact caused by saturated pixels.

The term “motion blur” as used herein, generally refers to a degradation factor that causes one or more objects in an image to appear vague, and/or indistinct due to a motion of a camera capturing the image, a motion of the one or more objects, or a combination of the two. In some examples, a motion blur may be perceived as streaking or smearing in the image. The term “lens blur” as used herein, generally refers to a degradation factor that causes an image to appear to have a narrower depth of field than the scene being captured. For example, certain objects in an image may be in focus, whereas other objects may appear out of focus.

The term “image noise” as used herein, generally refers to a degradation factor that causes an image to appear to have artifacts (e.g., specks, color dots, and so forth) resulting from a lower signal-to-noise ratio (SNR). For example, an SNR below a certain desired threshold value may cause image noise. In some examples, image noise may occur due to an image sensor, or a circuitry in a camera. The term “image compression artifact” as used herein, generally refers to a degradation factor that results from lossy image compression. For example, image data may be lost during compression, thereby resulting in visible artifacts in a decompressed version of the image.

The term “saturated pixels” as used herein, generally refers to a condition where pixels are saturated with photons, and the photons then spill over into adjacent pixels. For example, a saturated pixel may be associated with an image intensity of higher than a threshold intensity (e.g., higher than 245, or at 255, and so forth). Image intensity may correspond to an intensity of a grayscale, or an intensity of a color component in red, blue, or green (RGB). For example, highly saturated pixels may appear as brightly colored. Accordingly, the spilling over of photons from saturated pixels into adjacent pixels may cause perceptive defects in an image (for example, causing a saturation of one or more adjacent pixels, distorting the intensity of the one or more adjacent pixels, and so forth).

### Training Machine Learning Models for Generating Inferences/Predictions

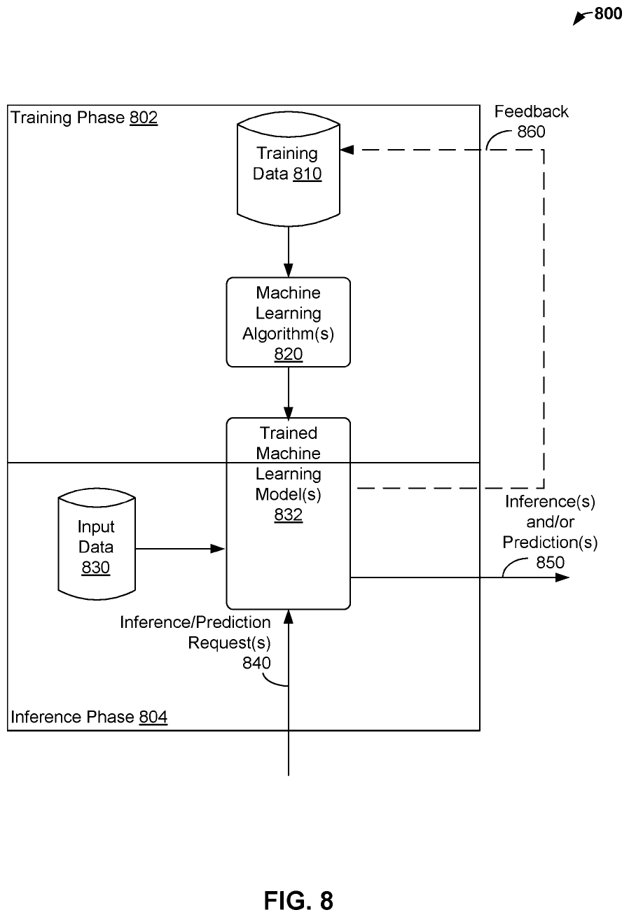

FIG. 8 shows diagram 800 illustrating a training phase 802 and an inference phase 804 of trained machine learning model(s) 832, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 8 shows training phase 802 where one or more machine learning algorithms 820 are being trained on training data 810 to become trained machine learning model(s) 832. Then, during inference phase 804, trained machine learning model(s) 832 can receive input data 830 and one or more inference/prediction requests 840 (perhaps as part of input data 830) and responsively provide as an output one or more inferences and/or prediction(s) 850.

For example, the one or more machine learning algorithms 820 may include a quality assessment model (e.g., a deep model, such as a MobileNet-V2 model), a delta scoring model (e.g., Δ-NIMA predictor), an image enhancement model (e.g., DeepMode, deblurring model, colorization model, artifact removal model, and so forth), a trigger model, an image ranking model, and so forth. The trained machine learning model(s) 832 can be the respective trained versions of these one or more machine learning algorithms 820.

As such, trained machine learning model(s) 832 can include one or more models of one or more machine learning algorithms 820. Machine learning algorithm(s) 820 may include, but are not limited to: an artificial neural network (e.g., herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 820 may be supervised or unsupervised, and may implement any suitable combination of online and offline learning.

In some examples, machine learning algorithm(s) 820 and/or trained machine learning model(s) 832 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 820 and/or trained machine learning model(s) 832. In some examples, trained machine learning model(s) 832 can be trained, can reside on, and be executed to provide inferences on a particular computing device, and/or otherwise can make inferences for the particular computing device.

During training phase 802, machine learning algorithm(s) 820 can be trained by providing at least training data 810 as training input using unsupervised, supervised, semi-supervised, and/or reinforcement learning techniques. Unsupervised learning involves providing a portion (or all) of training data 810 to machine learning algorithm(s) 820 and machine learning algorithm(s) 820 determining one or more output inferences based on the provided portion (or all) of training data 810. Supervised learning involves providing a portion of training data 810 to machine learning algorithm(s) 820, with machine learning algorithm(s) 820 determining one or more output inferences based on the provided portion of training data 810, and the output inference(s) are either accepted or corrected based on correct results associated with training data 810. In some examples, supervised learning of machine learning algorithm(s) 820 can be governed by a set of rules and/or a set of labels for the training input, and the set of rules and/or set of labels may be used to correct inferences of machine learning algorithm(s) 820.

Semi-supervised learning involves having correct results for part, but not all, of training data 810. During semi-supervised learning, supervised learning is used for a portion of training data 810 having correct results, and unsupervised learning is used for a portion of training data 810 not having correct results. Reinforcement learning involves machine learning algorithm(s) 820 receiving a reward signal regarding a prior inference, where the reward signal can be a numerical value. During reinforcement learning, machine learning algorithm(s) 820 can output an inference and receive a reward signal in response, where machine learning algorithm(s) 820 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 820 and/or trained machine learning model(s) 832 can be trained using other machine learning techniques, including but not limited to, incremental learning and curriculum learning.

In some examples, machine learning algorithm(s) 820 and/or trained machine learning model(s) 832 can use transfer learning techniques. For example, transfer learning techniques can involve trained machine learning model(s) 832 being pre-trained on one set of data and additionally trained using training data 810. More particularly, machine learning algorithm(s) 820 can be pre-trained on data from one or more computing devices and a resulting trained machine learning model provided to computing device CD1, where CD1 is intended to execute the trained machine learning model during inference phase 804. Then, during training phase 802, the pre-trained machine learning model can be additionally trained using training data 810, where training data 810 can be derived from kernel and non-kernel data of computing device CD1. This further training of the machine learning algorithm(s) 820 and/or the pre-trained machine learning model using training data 810 of CD1's data can be performed using either supervised or unsupervised learning. Once machine learning algorithm(s) 820 and/or the pre-trained machine learning model has been trained on at least training data 810, training phase 802 can be completed. The trained resulting machine learning model can be utilized as at least one of trained machine learning model(s) 832.

In particular, once training phase 802 has been completed, trained machine learning model(s) 832 can be provided to a computing device, if not already on the computing device. Inference phase 804 can begin after trained machine learning model(s) 832 are provided to computing device CD1.

During inference phase 804, trained machine learning model(s) 832 can receive input data 830 and generate and output one or more corresponding inferences and/or prediction(s) 850 about input data 830. As such, input data 830 can be used as an input to trained machine learning model(s) 832 for providing corresponding inference(s) and/or prediction(s) 850 to kernel components and non-kernel components. For example, trained machine learning model(s) 832 can generate inference(s) and/or prediction(s) 850 in response to one or more inference/prediction requests 840. In some examples, trained machine learning model(s) 832 can be executed by a portion of other software. For example, trained machine learning model(s) 832 can be executed by an inference or prediction daemon to be readily available to provide inferences and/or predictions upon request. Input data 830 can include data from computing device CD1 executing trained machine learning model(s) 832 and/or input data from one or more computing devices other than CD1.

Input data 830 can include training data described herein, such as images associated with delta quality scores, human annotated data, real blurry images, synthetically generated images, images in the curated dataset, and so forth. Other types of input data are possible as well. For example, training data may include the data collected to train the image transformation model.

Inference(s) and/or prediction(s) 850 can include task outputs, numerical values, and/or other output data produced by trained machine learning model(s) 832 operating on input data 830 (and training data 810). In some examples, trained machine learning model(s) 832 can use output inference(s) and/or prediction(s) 850 as input feedback 850. Trained machine learning model(s) 832 can also rely on past inferences as inputs for generating new inferences.

After training, the trained version of the neural network can be an example of trained machine learning model(s) 832. In this approach, an example of the one or more inference/prediction request(s) 840 can be a request to predict a quality-improvability score, and/or a transformed (e.g., deblurred, denoised, etc.) image and a corresponding example of inferences and/or prediction(s) 850 can be a predicted quality-improvability score and/or a transformed (e.g., deblurred, denoised, etc.) image.

In some examples, one computing device CD_SOLO can include the trained version of the neural network, perhaps after training. Then, computing device CD_SOLO can receive a request to predict a quality-improvability score and/or a request to transform (e.g., deblurred, denoised, etc.) an image, and use the trained version of the neural network to predict the quality-improvability score and/or the transformed (e.g., deblurred, denoised, etc.) image.

In some examples, two or more computing devices CD_CLI and CD_SRV can be used to provide output: e.g., a first computing device CD_CLI can generate a request to predict a quality-improvability score and/or a transformed (e.g., deblurred, denoised, etc.) image to a second computing device CD_SRV. Then, CD_SRV can use the trained version of the neural network, to predict the quality-improvability score and/or the transformed (e.g., deblurred, denoised, etc.) image, and respond to the requests from CD_CLI. Then, upon reception of responses to the requests. CD_CLI can provide the requested output (e.g., using a user interface and/or a display, a printed copy, an electronic communication, etc.).

### Example Data Network

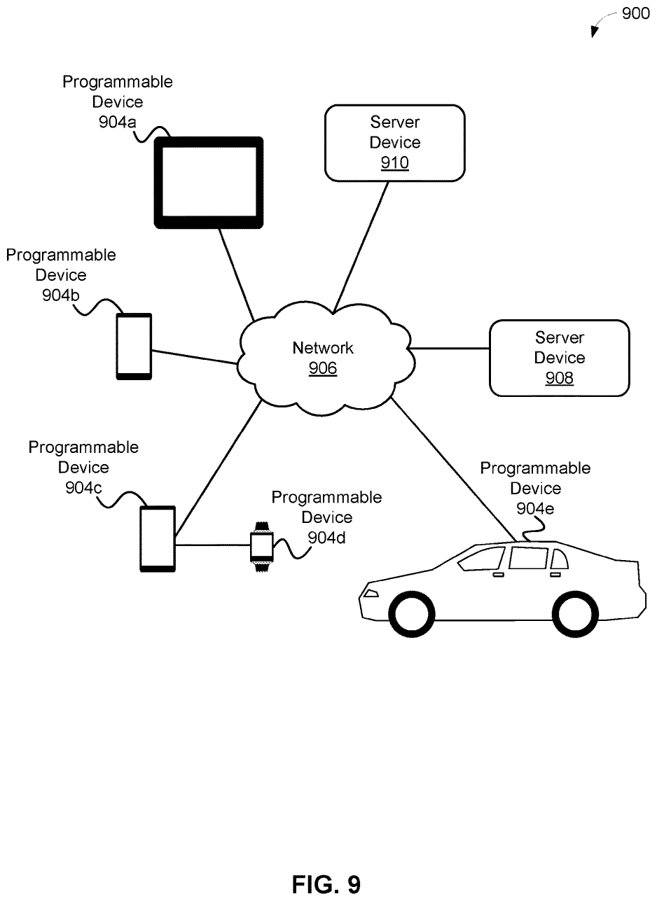

FIG. 9 depicts a distributed computing architecture 900, in accordance with example embodiments. Distributed computing architecture 900 includes server devices 908, 910 that are configured to communicate, via network 906, with programmable devices 904a, 904b, 904c, 904d. 904e. Network 906 may correspond to a local area network (LAN), a wide area network (WAN), a WLAN, a WWAN, a corporate intranet, the public Internet, or any other type of network configured to provide a communications path between networked computing devices. Network 906 may also correspond to a combination of one or more LANs, WANs, corporate intranets, and/or the public Internet.

Although FIG. 9 only shows five programmable devices, distributed application architectures may serve tens, hundreds, or thousands of programmable devices. Moreover, programmable devices 904a, 904b, 904c, 904d, 904e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 904a, 904b, 904c, 904e, programmable devices can be directly connected to network 906. In other examples, such as illustrated by programmable device 904d, programmable devices can be indirectly connected to network 906 via an associated computing device, such as programmable device 904c. In this example, programmable device 904c can act as an associated computing device to pass electronic communications between programmable device 904d and network 906. In other examples, such as illustrated by programmable device 904e, a computing device can be part of and/or inside a vehicle, such as a car, a truck, a bus, a boat or ship, an airplane, etc. In other examples not shown in FIG. 9, a programmable device can be both directly and indirectly connected to network 906.

Server devices 908, 910 can be configured to perform one or more services, as requested by programmable devices 904a-904e. For example, server device 908 and/or 910 can provide content to programmable devices 904a-904e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 908 and/or 910 can provide programmable devices 904a-904e with access to software for database, search, computation, graphical, audio, video, World Wide Web/Internet utilization, and/or other functions. Many other examples of server devices are possible as well.

### Computing Device Architecture

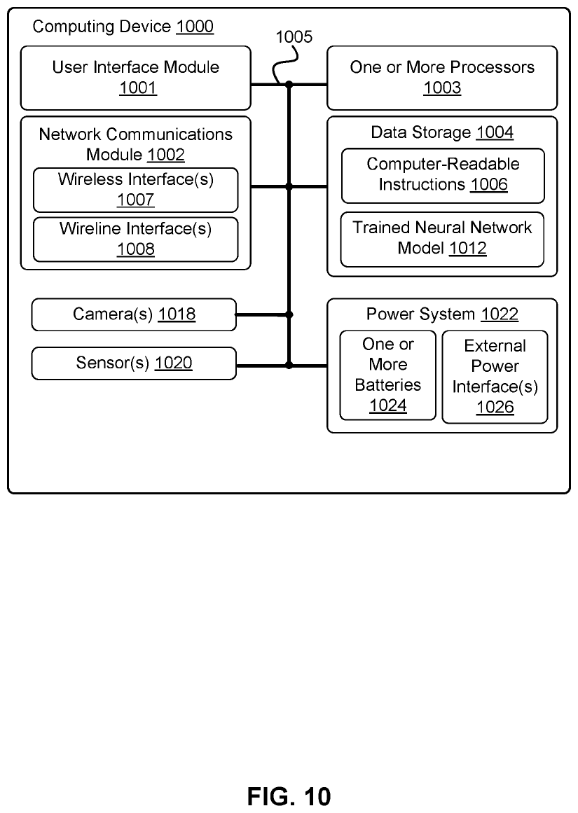

FIG. 10 is a block diagram of an example computing device 1000, in accordance with example embodiments. In particular, computing device 1000 shown in FIG. 10 can be configured to perform at least one function of and/or related to the neural networks described herein, and/or methods 1200, 1300.

Computing device 1000 may include a user interface module 1001, a network communications module 1002, one or more processors 1003, data storage 1004, one or more camera(s) 1018, one or more sensors 1020, and power system 1022, all of which may be linked together via a system bus, network, or other connection mechanism 1005.

User interface module 1001 can be operable to send data to and/or receive data from external user input/output devices. For example, user interface module 1001 can be configured to send and/or receive data to and/or from user input devices such as a touch screen, a computer mouse, a keyboard, a keypad, a touch pad, a trackball, a joystick, a voice recognition module, and/or other similar devices. User interface module 1001 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 1001 can also be configured to generate audible outputs, with devices such as a speaker, speaker jack, audio output port, audio output device, earphones, and/or other similar devices. User interface module 1001 can further be configured with one or more haptic devices that can generate haptic outputs, such as vibrations and/or other outputs detectable by touch and/or physical contact with computing device 1000. In some examples, user interface module 1001 can be used to provide a graphical user interface (GUI) for utilizing computing device 1000, such as, for example, a graphical user interface of a mobile phone device.

Network communications module 1002 can include one or more devices that provide one or more wireless interface(s) 1007 and/or one or more wireline interface(s) 1008 that are configurable to communicate via a network. Wireless interface(s) 1007 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 1008 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 1002 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES). Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 1003 can include one or more general purpose processors, and/or one or more special purpose processors (e.g., digital signal processors, tensor processing units (TPUs), graphics processing units (GPUs), application specific integrated circuits, etc.). One or more processors 1003 can be configured to execute computer-readable instructions 8306 that are contained in data storage 1004 and/or other instructions as described herein.

Data storage 1004 can include one or more non-transitory computer-readable storage media that can be read and/or accessed by at least one of one or more processors 1003. The one or more computer-readable storage media can include volatile and/or non-volatile storage components, such as optical, magnetic, organic or other memory or disc storage, which can be integrated in whole or in part with at least one of one or more processors 1003. In some examples, data storage 1004 can be implemented using a single physical device (e.g., one optical, magnetic, organic or other memory or disc storage unit), while in other examples, data storage 1004 can be implemented using two or more physical devices.

Data storage 1004 can include computer-readable instructions 1006 and perhaps additional data. In some examples, data storage 1004 can include storage required to perform at least part of the herein-described methods, scenarios, and techniques and/or at least part of the functionality of the herein-described devices and networks. In some examples, data storage 1004 can include storage for a trained neural network model 1012 (e.g., a model of trained neural networks such as neural network models described herein). In particular of these examples, computer-readable instructions 8306 can include instructions that, when executed by one or more processors 1003, enable computing device 1000 to provide for some or all of the functionality of trained neural network model 1012.

In some examples, computing device 1000 can include one or more camera(s) 1018. Camera(s) 1018 can include one or more image capture devices, such as still and/or video cameras, equipped to capture light and record the captured light in one or more images; that is, camera(s) 1018 can generate image(s) of captured light. The one or more images can be one or more still images and/or one or more images utilized in video imagery. Camera(s) 1018 can capture light and/or electromagnetic radiation emitted as visible light, infrared radiation, ultraviolet light, and/or as one or more other frequencies of light.

In some examples, computing device 1000 can include one or more sensors 1020. Sensors 1020 can be configured to measure conditions within computing device 1000 and/or conditions in an environment of computing device 1000 and provide data about these conditions. For example, sensors 1020 can include one or more of: (i) sensors for obtaining data about computing device 1000, such as, but not limited to, a thermometer for measuring a temperature of computing device 1000, a battery sensor for measuring power of one or more batteries of power system 1022, and/or other sensors measuring conditions of computing device 1000: (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information: (iii) sensors to measure locations and/or movements of computing device 1000, such as, but not limited to, a tilt sensor, a gyroscope, an accelerometer, a Doppler sensor, a GPS device, a sonar sensor, a radar device, a laser-displacement sensor, and a compass: (iv) an environmental sensor to obtain data indicative of an environment of computing device 1000, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 1000, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 1020 are possible as well.

Power system 1022 can include one or more batteries 1024 and/or one or more external power interfaces 1026 for providing electrical power to computing device 1000. Each battery of the one or more batteries 1024 can, when electrically coupled to the computing device 1000, act as a source of stored electrical power for computing device 1000. One or more batteries 1024 of power system 1022 can be configured to be portable. Some or all of one or more batteries 1024 can be readily removable from computing device 1000. In other examples, some or all of one or more batteries 1024 can be internal to computing device 1000, and so may not be readily removable from computing device 1000. Some or all of one or more batteries 1024 can be rechargeable. For example, a rechargeable battery can be recharged via a wired connection between the battery and another power supply, such as by one or more power supplies that are external to computing device 1000 and connected to computing device 1000 via the one or more external power interfaces. In other examples, some or all of one or more batteries 1024 can be non-rechargeable batteries.

One or more external power interfaces 1026 of power system 1022 can include one or more wired-power interfaces, such as a USB cable and/or a power cord, that enable wired electrical power connections to one or more power supplies that are external to computing device 1000. One or more external power interfaces 1026 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1026, computing device 1000 can draw electrical power from the external power source the established electrical power connection. In some examples, power system 1022 can include related sensors, such as battery sensors associated with the one or more batteries or other types of electrical power sensors.

### Cloud-Based Servers

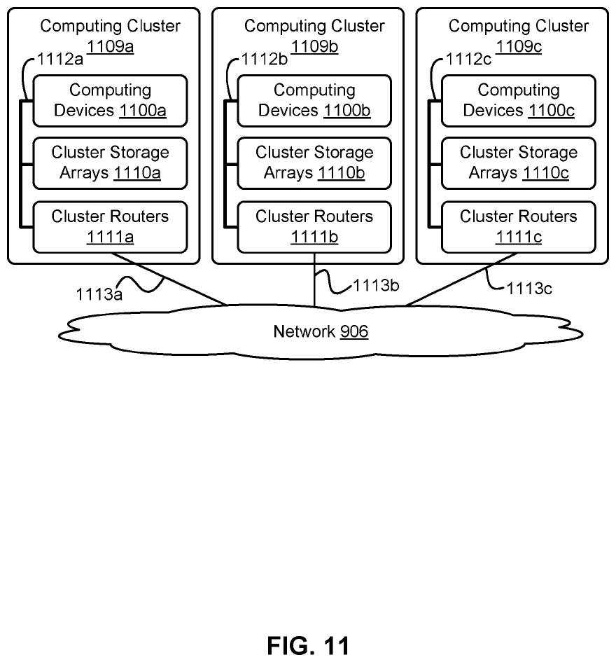

FIG. 11 depicts a cloud-based server system in accordance with an example embodiment. In FIG. 14, functionality of a neural network, and/or a computing device can be distributed among computing clusters 1109a, 1109b, 1109c. Computing cluster 1109a can include one or more computing devices 1100a, cluster storage arrays 1110a, and cluster routers 1111a connected by a local cluster network 1113a. Similarly, computing cluster 1109b can include one or more computing devices 1100b, cluster storage arrays 1110b, and cluster routers 1111b connected by a local cluster network 1113b. Likewise, computing cluster 1109c can include one or more computing devices 1100c, cluster storage arrays 1110c, and cluster routers 1111c connected by a local cluster network 1113c.

In some embodiments, computing clusters 1109a, 1109b, 1109c can be a single computing device residing in a single computing center. In other embodiments, computing clusters 1109a. 1109b. 1109c can include multiple computing devices in a single computing center, or even multiple computing devices located in multiple computing centers located in diverse geographic locations. For example. FIG. 11 depicts each of computing clusters 1109a, 1109b, 1109c residing in different physical locations.

In some embodiments, data and services at computing clusters 1109a. 1109b. 1109c can be encoded as computer readable information stored in non-transitory, tangible computer readable media (or computer readable storage media) and accessible by other computing devices. In some embodiments, computing clusters 1109a, 1109b, 1109c can be stored on a single disk drive or other tangible storage media, or can be implemented on multiple disk drives or other tangible storage media located at one or more diverse geographic locations.

In some embodiments, each of computing clusters 1109a. 1109b, and 1109c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 1109a, for example, computing devices 1100a can be configured to perform various computing tasks of a conditioned, axial self-attention based neural network, and/or a computing device. In one embodiment, the various functionalities of a neural network, and/or a computing device can be distributed among one or more of computing devices 1100a, 1100b. 1100c. Computing devices 1100b and 1100c in respective computing clusters 1109b and 1109c can be configured similarly to computing devices 1100a in computing cluster 1109a. On the other hand, in some embodiments, computing devices 1100a, 1100b, and 1100c can be configured to perform different functions.

In some embodiments, computing tasks and stored data associated with a neural network, and/or a computing device can be distributed across computing devices 1100a, 1100b, and 1100c based at least in part on the processing requirements of a neural network, and/or a computing device, the processing capabilities of computing devices 1100a. 1100b, 1100c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 1110a. 1110b, 1110c of computing clusters 1109a, 1109b, 1109c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of a conditioned, axial self-attention based neural network, and/or a computing device can be distributed across computing devices 1100a, 1100b, 1100c of computing clusters 1109a, 1109b, 1109c, various active portions and/or backup portions of these components can be distributed across cluster storage arrays 1110a. 1110b, 1110c. For example, some cluster storage arrays can be configured to store one portion of the data of a first layer of a neural network, and/or a computing device, while other cluster storage arrays can store other portion(s) of data of second layer of a neural network, and/or a computing device. Also, for example, some cluster storage arrays can be configured to store the data of an encoder of a neural network, while other cluster storage arrays can store the data of a decoder of a neural network. Additionally, some cluster storage arrays can be configured to store backup versions of data stored in other cluster storage arrays.

Cluster routers 1111a, 1111b, 1111c in computing clusters 1109a, 1109b, 1109c can include networking equipment configured to provide internal and external communications for the computing clusters. For example, cluster routers 1111a in computing cluster 1109a can include one or more internet switching and routing devices configured to provide (i) local area network communications between computing devices 1100a and cluster storage arrays 1110a via local cluster network 1113A, and (ii) wide area network communications between computing cluster 1109a and computing clusters 1109b and 1109c via wide area network link 1113a to network 906. Cluster routers 1111b and 1111c can include network equipment similar to cluster routers 1111a, and cluster routers 1111b and 1111c can perform similar networking functions for computing clusters 1109b and 1109b that cluster routers 1111a perform for computing cluster 1109a.

In some embodiments, the configuration of cluster routers 1111a, 1111b, 1111c can be based at least in part on the data communication requirements of the computing devices and cluster storage arrays, the data communications capabilities of the network equipment in cluster routers 1111a, 1111b, 1111c, the latency and throughput of local cluster networks 1113A, 1113B, 1113C, the latency, throughput, and cost of wide area network links 1113a, 1113b, 1113c, and/or other factors that can contribute to the cost, speed, fault-tolerance, resiliency, efficiency and/or other design criteria of the moderation system architecture.

### Example Methods of Operation

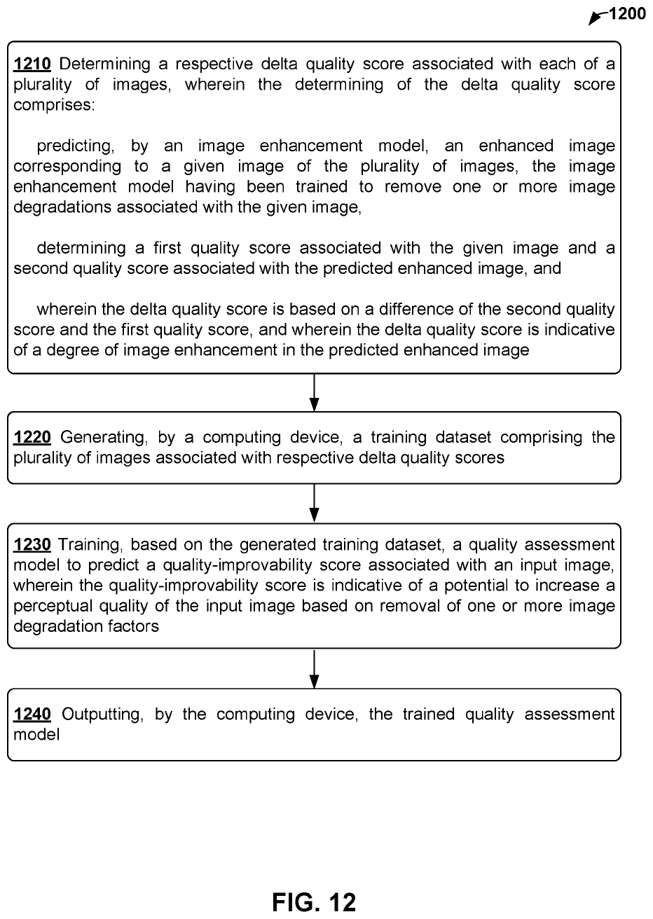

FIG. 12 is a flowchart of a method 1200, in accordance with example embodiments. Method 1200 can be executed by a computing device, such as computing device 1000.

Method 1200 can begin at block 1210, where the method involves determining a respective delta quality score associated with each of a plurality of images, wherein the determining of the delta quality score comprises: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image.

At block 1220, the method involves generating, by a computing device, a training dataset comprising the plurality of images associated with respective delta quality scores.

At block 1230, the method involves training, based on the generated training dataset, a quality assessment model to predict a quality-improvability score associated with an input image, wherein the quality-improvability score is indicative of a potential to increase a perceptual quality of the input image based on removal of one or more image degradation factors.

At block 1240, the method involves outputting, by the computing device, the trained quality assessment model.

In some embodiments, the quality assessment model may be a convolutional neural network, and the training of the quality assessment model involves receiving labeled data indicating the degree of image enhancement in the predicted enhanced image as perceived by human annotators. Such embodiments involve fine-tuning a last layer of the convolutional neural network with the received labeled data.

In some embodiments, the convolutional neural network includes a MobileNet architecture.

In some embodiments, the convolutional neural network includes a fully connected layer configured to determine the delta quality score.

In some embodiments, the first quality score and the second quality score may be neural image assessment (NIMA) scores.

In some embodiments, the first quality score and the second quality score may be generated by an AlexNet based convolutional neural network (CNN) that has been trained on Aesthetic Visual Analysis (AVA) with a rank-based loss function.

In some embodiments, the one or more image degradation factors include one or more of a motion blur, a lens blur, an image noise, an image compression artifact, or an artifact caused by saturated pixels.

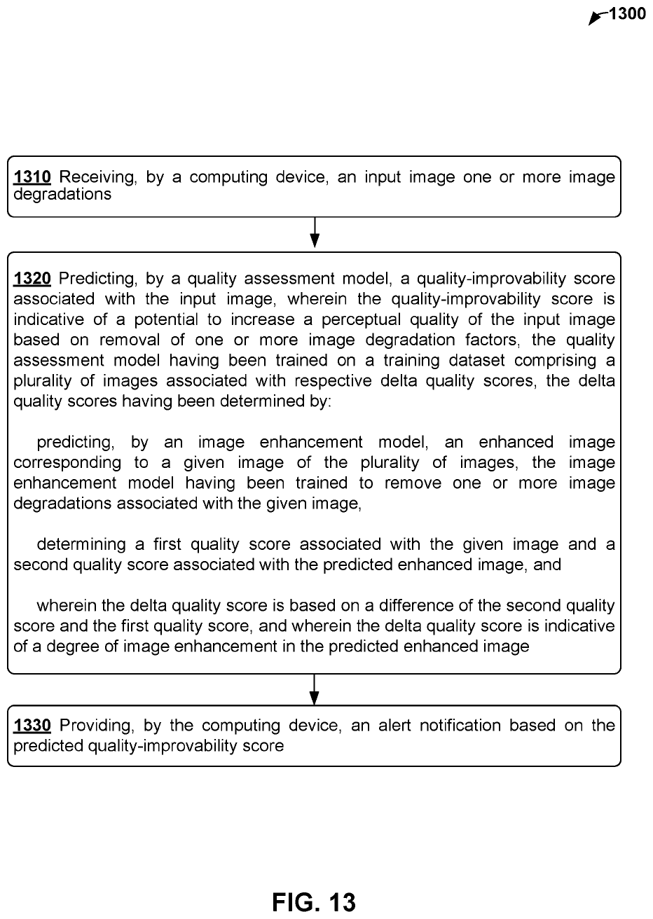

FIG. 13 is a flowchart of a method 1300, in accordance with example embodiments. Method 1300 can be executed by a computing device, such as computing device 1000.

Method 1300 can begin at block 1310, where the method involves receiving, by a computing device, an input image.

At block 1320, the method involves predicting, by a quality assessment model, a quality-improvability score associated with the input image, wherein the quality-improvability score is indicative of a potential to increase a perceptual quality of the input image based on removal of one or more image degradation factors, the quality assessment model having been trained on a training dataset comprising a plurality of images associated with respective delta quality scores, the delta quality scores having been determined by: predicting, by an image enhancement model, an enhanced image corresponding to a given image of the plurality of images, the image enhancement model having been trained to remove one or more image degradations associated with the given image, determining a first quality score associated with the given image and a second quality score associated with the predicted enhanced image, and wherein the delta quality score is based on a difference of the second quality score and the first quality score, and wherein the delta quality score is indicative of a degree of image enhancement in the predicted enhanced image.

At block 1330, the method involves providing, by the computing device, an alert notification based on the predicted quality-improvability score.

In some embodiments, the quality assessment model may be a convolutional neural network.

In some embodiments, the convolutional neural network includes a MobileNet architecture.

In some embodiments, the convolutional neural network includes a fully connected layer configured to determine the delta quality score.

In some embodiments, the first quality score and the second quality score may be neural image assessment (NIMA) scores.

In some embodiments, the first quality score and the second quality score may be generated by an AlexNet based convolutional neural network (CNN) that has been trained on Aesthetic Visual Analysis (AVA) with a rank-based loss function.

Some embodiments involve determining whether the predicted quality-improvability score exceeds a threshold score. Such embodiments involve based upon a determination that the predicted quality-improvability score exceeds the threshold score, providing the input image to the image enhancement model to enhance the quality of the input image.

In some embodiments, the one or more image degradation factors include image blurring. The threshold score may be a threshold deblurring score.

In some embodiments, the one or more image degradation factors include image noise. The threshold score may be a threshold denoising score.

In some embodiments, the one or more image degradation factors include an image compression artifact. The threshold score may be a threshold compression artifact removal score.

In some embodiments, the one or more image degradation factors include an artifact caused by saturated pixels. The threshold score may be a threshold saturated pixel artifact removal score.

In some embodiments, the providing of the alert notification involves triggering the alert notification upon a determination that the predicted quality-improvability score exceeds the threshold score.

In some embodiments, the providing of the alert notification involves, upon a determination that the predicted quality-improvability score exceeds the threshold score, providing a recommendation to a user to enhance the input image.

Some embodiments involve receiving a user indication to enhance the input image. Such embodiments involve, responsive to the user indication, providing the input image to the image enhancement model to enhance the input image.

In some embodiments, the image enhancement model may be one or more of a deblurring model, a colorization model, an image artifact removal model, or a denoising model.

In some embodiments, the one or more image degradation factors include one or more of a motion blur, or a lens blur.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are provided for explanatory purposes and are not intended to be limiting, with the true scope being associated with the following claims.

1. A computer-implemented method, comprising:
determining a respective delta quality score associated with each of a plurality of images, wherein the determining of the delta quality score comprises:
predicting, by an image enhancement model, an enhanced image corresponding to a given image of the plurality of images, the image enhancement model having been trained to remove one or more image degradations associated with the given image,
determining a first quality score associated with the given image and a second quality score associated with the predicted enhanced image, and
wherein the delta quality score is based on a difference of the second quality score and the first quality score, and wherein the delta quality score is indicative of a degree of image enhancement in the predicted enhanced image;
generating, by a computing device, a training dataset comprising the plurality of images associated with respective delta quality scores;
training, based on the generated training dataset, a quality assessment model to predict a quality-improvability score associated with an input image, wherein the quality-improvability score is indicative of a potential to increase a perceptual quality of the input image based on removal of one or more image degradation factors; and
outputting, by the computing device, the trained quality assessment model.

2. The computer-implemented method of claim 1, wherein the quality assessment model is a convolutional neural network, and wherein the training of the quality assessment model further comprises:
receiving labeled data indicating the degree of image enhancement in the predicted enhanced image as perceived by human annotators; and
fine-tuning a last layer of the convolutional neural network with the received labeled data.

3. The computer-implemented method of claim 2, wherein the convolutional neural network comprises a MobileNet architecture.

4. The computer-implemented method of claim 2, wherein the convolutional neural network comprises a fully connected layer configured to determine the delta quality score.

5. The computer-implemented method of claim 1, wherein the first quality score and the second quality score are neural image assessment (NIMA) scores.

6. The computer-implemented method of claim 1, wherein the first quality score and the second quality score are generated by an AlexNet based convolutional neural network (CNN) that has been trained on Aesthetic Visual Analysis (AVA) with a rank-based loss function.

7. The computer-implemented method of claim 1, wherein the one or more image degradation factors comprise one or more of a motion blur, a lens blur, an image noise, an image compression artifact, or an artifact caused by saturated pixels.

8. A computer-implemented method, comprising:
receiving, by a computing device, an input image;
predicting, by a quality assessment model, a quality-improvability score associated with the input image, wherein the quality-improvability score is indicative of a potential to increase a perceptual quality of the input image based on removal of one or more image degradation factors, the quality assessment model having been trained on a training dataset comprising a plurality of images associated with respective delta quality scores, the delta quality scores having been determined by:
predicting, by an image enhancement model, an enhanced image corresponding to a given image of the plurality of images, the image enhancement model having been trained to remove one or more image degradations associated with the given image,
determining a first quality score associated with the given image and a second quality score associated with the predicted enhanced image, and
wherein the delta quality score is based on a difference of the second quality score and the first quality score, and wherein the delta quality score is indicative of a degree of image enhancement in the predicted enhanced image; and
providing, by the computing device, an alert notification based on the predicted quality-improvability score.

9. The computer-implemented method of claim 8, wherein the quality assessment model is a convolutional neural network.

10. The computer-implemented method of claim 8, wherein the convolutional neural network comprises a MobileNet architecture.

11. The computer-implemented method of claim 8, wherein the convolutional neural network comprises a fully connected layer configured to determine the delta quality score.

12. The computer-implemented method of claim 8, wherein the first quality score and the second quality score are neural image assessment (NIMA) scores.

13. The computer-implemented method of claim 8, wherein the first quality score and the second quality score are generated by an AlexNet based CNN that has been trained on Aesthetic Visual Analysis (AVA) with a rank-based loss function.

14. The computer-implemented method of claim 8, further comprising:
determining whether the predicted quality-improvability score exceeds a threshold score; and
based upon a determination that the predicted quality-improvability score exceeds the threshold score, providing the input image to the image enhancement model to enhance the quality of the input image.

15. The computer-implemented method of claim 14, wherein the one or more image degradation factors comprises image blurring, and wherein the threshold score is a threshold deblurring score.

16. The computer-implemented method of claim 14, wherein the one or more image degradation factors comprises image noise, wherein the threshold score is a threshold denoising score.

17. The computer-implemented method of claim 14, wherein the one or more image degradation factors comprises an image compression artifact, and wherein the threshold score is a threshold compression artifact removal score.

18. The computer-implemented method of claim 14, wherein the one or more image degradation factors comprises an artifact caused by saturated pixels, and wherein the threshold score is a threshold saturated pixel artifact removal score.

19. The computer-implemented method of claim 14, wherein the providing of the alert notification comprises:
triggering the alert notification upon a determination that the predicted quality-improvability score exceeds the threshold score.

20. The computer-implemented method of claim 14, wherein the providing of the alert notification comprises:
upon a determination that the predicted quality-improvability score exceeds the threshold score, providing a recommendation to a user to enhance the input image.

21. The computer-implemented method of claim 20, further comprising:
receiving a user indication to enhance the input image; and
responsive to the user indication, providing the input image to the image enhancement model to enhance the input image.

22. The computer-implemented method of claim 20, wherein the image enhancement model is one or more of a deblurring model, a colorization model, an image artifact removal model, or a denoising model.

23. The computer-implemented method of claim 8, wherein the one or more image degradation factors comprise one or more of a motion blur, or a lens blur.

24. A computing device, comprising:
one or more processors; and
data storage, wherein the data storage has stored thereon computer-executable instructions that, when executed by the one or more processors, cause the computing device to carry out functions comprising:
receiving, by the computing device, an input image;
predicting, by a quality assessment model, a quality-improvability score associated with the input image, wherein the quality-improvability score is indicative of a potential to increase a perceptual quality of the input image based on removal of one or more image degradation factors, the quality assessment model having been trained on a training dataset comprising a plurality of images associated with respective delta quality scores, the delta quality scores having been determined by:
predicting, by an image enhancement model, an enhanced image corresponding to a given image of the plurality of images, the image enhancement model having been trained to remove one or more image degradations associated with the given image,
determining a first quality score associated with the given image and a second quality score associated with the predicted enhanced image, and
wherein the delta quality score is based on a difference of the second quality score and the first quality score, and wherein the delta quality score is indicative of a degree of image enhancement in the predicted enhanced image; and
providing, by the computing device, an alert notification based on the predicted quality-improvability score.

25. (canceled)

26. (canceled)

27. (canceled)

28. (canceled)
